(19) United States
(12) Patent Application Publication
(10) Pub. No.: US 2025/0287276 A1
(43) Pub. Date: Sep. 11, 2025

(54) Methods And Apparatus For Conditional Layer 1/Layer 2 Triggered Mobility In Mobile Communications

(71) Applicant: MediaTek Singapore Pte. Ltd., Singapore (SG)

(72) Inventors: Xiaonan Zhang, Beijing (CN); Miao Wang, Beijing (CN)

(21) Appl. No.: 19/071,850

(22) Filed: Mar. 6, 2025

(30) Foreign Application Priority Data
Mar. 11, 2024 (WO) PCT/CN2024/080978
Mar. 3, 2025 (CN) 202510245397.9

(51) Int. Cl. H04W 36/00; H04W 74/0833

(52) U.S. Cl. CPC H04W 36/0085; H04W 36/0058; H04W 74/0833

(57) ABSTRACT

Various solutions for conditional layer 1/layer 2 triggered mobility (LTM) in mobile communications are described. A user equipment (UE) may receive a configuration from a network node and may perform a measurement based on the configuration. Also, the UE may trigger a conditional LTM decision in an event that a triggering event is determined to have occurred based on the measurement, then the UE may perform an LTM execution procedure according to the conditional LTM decision. UE-triggered LTM decisions enhance UE autonomy and flexibility. Furthermore, the LTM decisions made by UE may be more accurate and reasonable due to the UE's more detailed measurement context of its radio environment.

### CROSS REFERENCE TO RELATED PATENT APPLICATION(S)

The present disclosure is part of a non-provisional application claiming the priority benefit of PCT Application No. PCT/CN2024/080978, filed 11 Mar. 2024, and CN application Ser. No. 202510245397.9, filed 3 Mar. 2025. The contents of aforementioned applications are herein incorporated by reference in their entirety.

### TECHNICAL FIELD

The present disclosure is generally related to mobile communications and, more particularly, to conditional layer 1/layer 2 triggered mobility (LTM) with respect to user equipment and network apparatus in mobile communications.

### BACKGROUND

Unless otherwise indicated herein, approaches described in this section are not prior art to the claims listed below and are not admitted as prior art by inclusion in this section.

In mobile communications, handover refers a process of transferring an ongoing communication session of a user equipment (UE) from one cell to another in connected state, such that seamless connectivity and continuity of service for the user can be ensured, especially when the user is on the move. In legacy handover (e.g., a type of cell switch) specified in 3^{rd} Generation Partnership Project (3GPP) Release 17, a serving cell switch is triggered by layer 3 (L3) measurements with radio resource control (RRC) signaling for switching from a serving cell to a target cell. This L3 based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time. Advanced to Release 18, a lower layer triggered mobility (also called layer 1 (L1)/layer 2 (L2) triggered mobility, LTM) is introduced to enable the cell switch procedure via L1 or L2 signaling, which can keep configuration of the upper layers and/or minimize changes of configuration of the lower layers for reducing latency during the cell switch procedure.

In the current LTM procedure, the network decides the target cell. UE is informed of the target cell through an LTM cell switch command transmitted via a medium access control (MAC)-control element (CE). However, the transmission of the MAC-CE can be significantly impacted by channel quality degradation, potentially leading to radio link failure. Moreover, deciding the target cell by the network may be inaccurate due to a lack of detailed measurement context at the network side. Therefore, there is a need to develop a more reliable mechanism for the LTM procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to conditional layer 1/layer 2 triggered mobility (LTM) with respect to user equipment (UE) and network apparatus in mobile communications.

In one aspect, a method may involve an apparatus receiving configuration from a network node. The method may involve the apparatus performing a measurement based on the configuration. The method may also involve the apparatus triggering a conditional LTM decision in an event that a triggering event is determined to have occurred based on the measurement. The method may further involve the apparatus performing an LTM execution procedure according to the conditional LTM decision.

In one aspect, an apparatus may comprise a transceiver which, during operation, wirelessly communicates with a network node. The apparatus may also comprise a processor communicatively coupled to the transceiver. The processor, during operation, may perform operations comprising receiving, via the transceiver, a configuration from the network node. Also, the processor may perform operations comprising performing a measurement based on the configuration. Further, the processor may perform operations comprising triggering a conditional LTM decision in an event that a triggering event is determined to have occurred based on the measurement. Furthermore, the processor may perform operations comprising performing an LTM execution procedure according to the conditional LTM decision.

In another aspect, a method may involve a network node transmitting a configuration for a conditional LTM to a UE. The configuration may be associated with a triggering event of a conditional LTM decision. The method may also involve the network node receiving an indication of a target cell determined by the conditional LTM decision.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with implementations of the present disclosure.

FIG. 2 is a diagram depicting an example scenario of conditional layer 1/layer 2 triggered mobility (LTM) in accordance with implementations of the present disclosure.

FIG. 3 illustrates an example scenario of options for conditional LTM decision triggering times in accordance with an implementation of the present disclosure.

FIG. 4 illustrates an example scenario of performing LTM execution for conditional LTM in accordance with an implementation of the present disclosure.

FIG. 5 illustrates example scenarios of performing downlink (DL) synchronization for conditional LTM in accordance with an implementation of the present disclosure.

FIG. 6 illustrates example scenarios of performing uplink (UL) synchronization for conditional LTM in accordance with an implementation of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to conditional layer 1/layer 2 triggered mobility (LTM) in mobile communications. According to the present disclosure, a number of possible solutions may be implemented separately or jointly. That is, although these possible solutions may be described below separately, two or more of these possible solutions may be implemented in one combination or another.

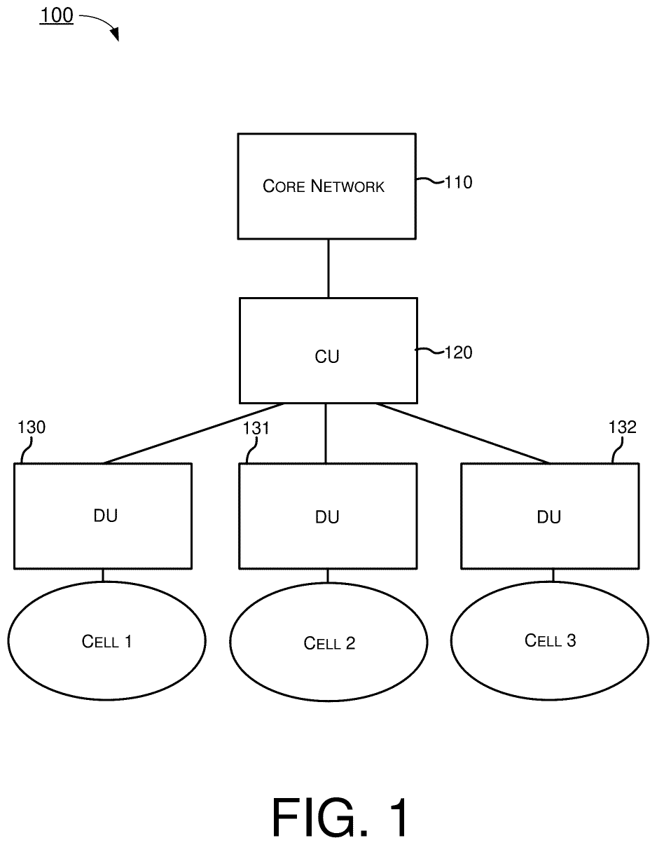

FIG. 1 illustrates an example mobile communication network 100 in accordance with an implementation of the present disclosure. As shown in FIG. 1, the mobile communication network 100 supports various wireless communication services and may be functionally operated with different protocol split options among at least a core network 110 and a plurality of BSs, e.g., evolved NodeBs (eNBs), next generation NodeBs (gNBs), or transmission and reception points (TRPs). In some implementations, the plurality of BSs may be gNBs implemented as a central unit (CU) 120 and distributed units (DUs) 130-132 associated with serving coverages/cells (e.g., Cells 1-3). In some implementations, service data application protocol (SDAP) and packet data convergence protocol (PDCP) layers may be located in the CU 120, and radio link control (RLC), medium access control (MAC) and physical (PHY) layers may be located in the DUs 130-132.

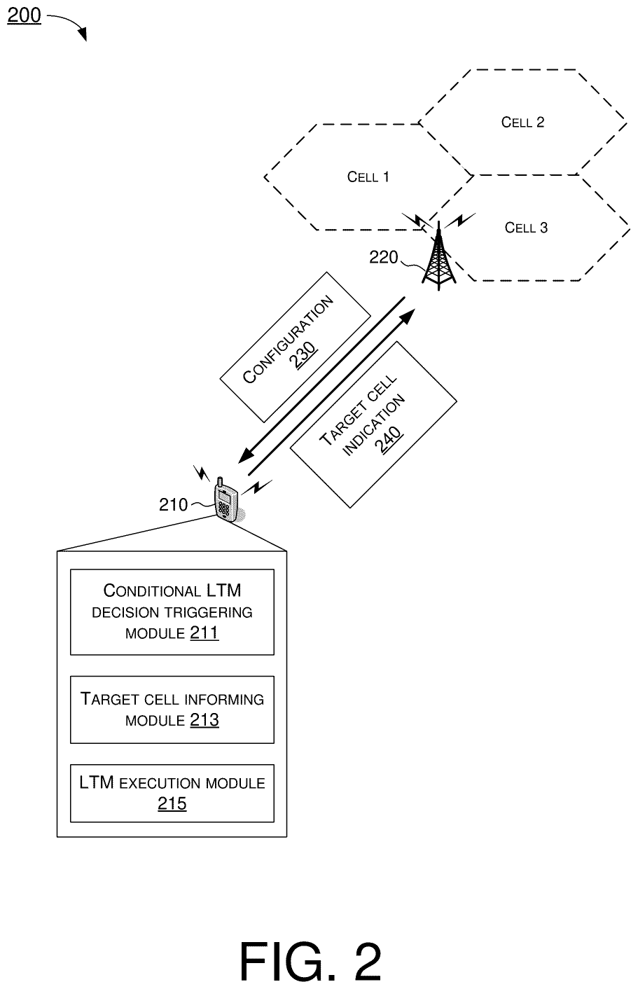

FIG. 2 is a diagram depicting an example scenario of conditional LTM in accordance with implementations of the present disclosure. In scenario 200, a UE 210 connects to a BS 220. In one example, the UE 210 may be a smartphone and includes at least a conditional LTM decision triggering module 211, a target cell informing module 213, and an LTM executional module 215, where each of the foregoing modules may be implemented by hardware and/or software, the present disclosure is not limited thereto. The BS 220 is implemented as the CU 120 and the DUs 130-132 as shown in FIG. 1 and corresponds to the Cells 1-3. In scenario 200, the conditional intra-CU LTM is supported. That is, the UE 210 may trigger a conditional LTM decision when the UE-evaluated condition is satisfied (e.g., a triggering event has occurred), and then switch from a source cell (e.g., Cell 1) to a target cell (e.g., Cell 2 or Cell 3) determined by the UE 210. To be specific, the BS 220 may transmit a configuration 230 for conditional LTM, so that the conditional LTM decision triggering module 211 of the UE 210 may perform at least one measurement based on the received configuration 230. The measurement(s) may include a layer 1 (L1) measurement, a layer 2 (L2) measurement, a layer 3 (L3) measurement, or other types of measurement. Further, the conditional LTM decision triggering module 211 may determine whether the triggering event has occurred based on the measurement(s) and trigger the conditional LTM decision if a triggering event is determined to have occurred. The triggering of the conditional LTM decision indicates that the UE 210 has determined the target cell for the conditional LTM. In one embodiment, the target cell informing module 213 may transmit an indication 240 of the target cell to the BS 220 via an L1 measurement report or a preamble. The LTM executional module 215 may perform an LTM execution procedure by switching from the source cell to the target cell.

The conditional LTM decision is triggered by the UE 210 upon the occurrence of a predetermined triggering event. In one embodiment, the triggering event is configured/predetermined in the configuration 230 received by the UE 210. The configuration 230 may be received in an LTM preparation stage. In one example, the triggering event is predetermined as a measurement result reaches a preconfigured threshold. In another example, the triggering event is predetermined as an event triggered L1 measurement report is transmitted by the UE 210.

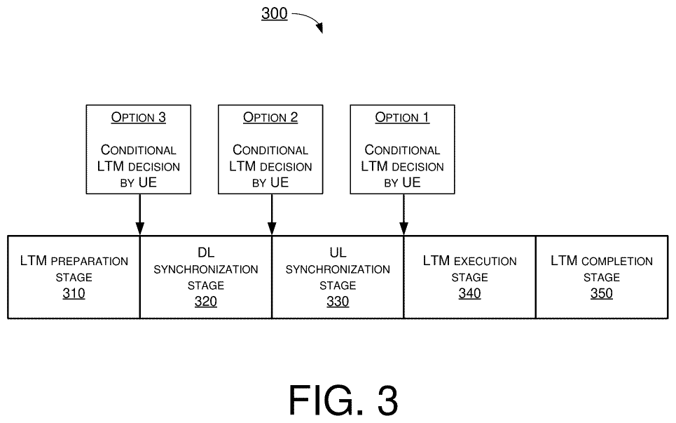

FIG. 3 illustrates an example scenario of options for conditional LTM decision triggering times in an implementation of the present disclosure. In scenario 300, a conditional LTM procedure may include an LTM preparation stage 310, a downlink (DL) synchronization stage 320, an uplink (UL) synchronization stage 330, an LTM execution stage 340, and an LTM completion stage 350. The UE 210 may trigger the conditional LTM decision at different timings corresponding to options 1 to 3. The triggering of the conditional LTM decision represents that the target cell for mobility has been chosen by the UE 210. As the target cell has been chosen, the UE 210 may detach from the source cell and apply the configuration for the target cell during the LTM execution stage 340. Further, the UE 210 may send a completion message (e.g., RRCReconfigurationComplete) to the target cell during the LTM completion stage 350.

In option 1, the UE 210 triggers the conditional LTM decision after the early synchronization procedure. To be specific, after the LTM preparation stage 310, the UE 210 performs a DL synchronization and a UL synchronization to candidate cells in the DL and UL synchronization stages 320 and 330, respectively. Then, the UE 210 decides the target cell for conditional LTM (i.e., triggers the conditional LTM decision). After that, the UE 210 performs an LTM execution procedure in the LTM execution stage 340 and an LTM completion procedure in the LTM completion stage 350. In one embodiment, the L1 measurement report before the UE 210 triggers the conditional LTM decision may be the periodic/semi-persistent/aperiodic L1 measurement report as designed in Release 18.

In option 2, the UE 210 triggers the conditional LTM decision after the DL synchronization stage 320 and before the UL synchronization stage 330. Specifically, after the LTM preparation stage 310, the UE 210 performs a DL synchronization to candidate cells in the DL synchronization stage 320. Then, the UE 210 decides the target cell for conditional LTM (i.e., triggers the conditional LTM decision) prior to the UL synchronization stage 330. After triggering the conditional LTM decision, the UE 210 performs the UL synchronization, LTM execution, and LTM completion procedures in the UL synchronization stage 330, the LTM execution stage 340, and the LTM completion stage 350, respectively. In one embodiment, the L1 measurement report before the UE 210 triggers the conditional LTM decision is the periodic/semi-persistent/aperiodic L1 measurement report as designed in Release 18. In one embodiment, the L1 measurement report after the UE 210 triggers the conditional LTM decision is the event triggered L1 measurement report.

In option 3, the UE 210 triggers the conditional LTM decision before the DL and UL synchronization stages 320 and 330. For example, the UE 210 decides the target cell for conditional LTM (i.e., triggers the conditional LTM decision) right after the LTM preparation stage 310. Then, the UE 210 performs the DL synchronization, UL synchronization, LTM execution, and LTM completion procedures in the DL synchronization stage 320, the UL synchronization stage 330, the LTM execution stage 340, and the LTM completion stage 350, respectively. In one embodiment, the L1 measurement report after the UE 210 triggers the conditional LTM decision is the event triggered L1 measurement report.

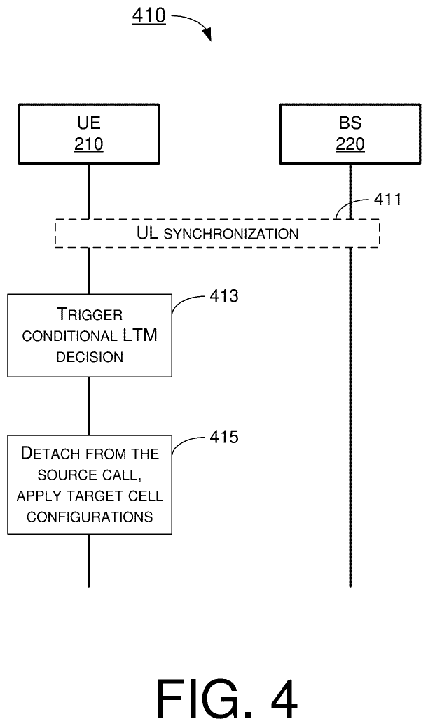

FIG. 4 is a diagram depicting an example scenario of performing LTM execution for conditional LTM in accordance with an implementation of the present disclosure. As shown in scenario 410, the LTM execution procedure is triggered by the conditional LTM decision after the early synchronization procedure. For example, after operation 411 for the UL synchronization procedure is finished, the UE 210 triggers the conditional LTM decision as shown in operation 413. Then, the UE 210 performs the LTM execution procedure by detaching from the source cell and apply the target cell configurations as shown in operation 415. In another embodiment, the conditional LTM decision may be triggered before the UE 210 completes the early synchronization procedure. In such a case, the LTM execution procedure is performed after the UE 210 completes early synchronization procedure.

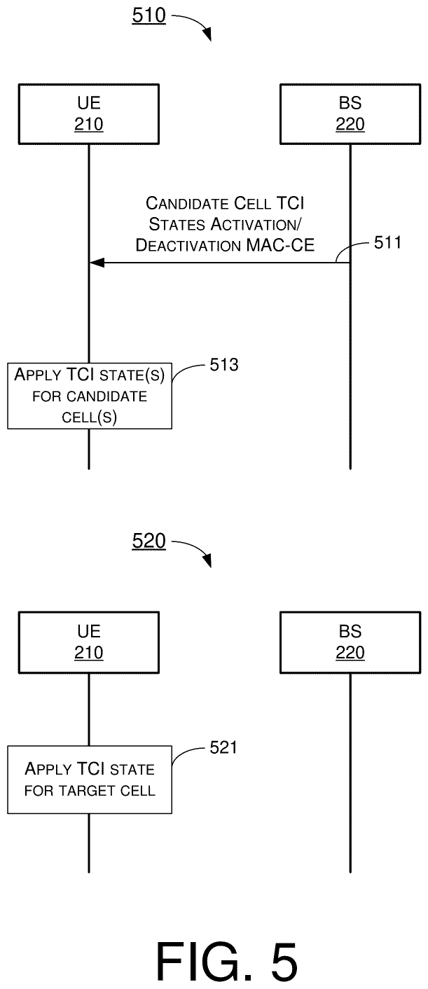

FIG. 5 is a diagram depicting example scenarios of performing DL synchronization for conditional LTM in accordance with an implementation of the present disclosure. The DL synchronization may be performed differently depending on the timing of the conditional LTM decision trigger. In one embodiment, it is assumed that the UE 210 performs the DL synchronization before deciding the target cell for conditional LTM (i.e., before triggering the conditional LTM decision), as shown in options 1 and 2 in FIG. 3. As shown in scenario 510, the UE 210 may receive a medium access control (MAC)-control element (CE) indicating the transmission configuration indicator (TCI) state(s) for candidate cell(s) from the BS 220 in operation 511. Then, the UE 210 may perform the DL synchronization with the candidate cell(s), such as in operation 513, the UE 210 may apply the TCI state(s) for the candidate cell(s).

In another embodiment, it is assumed that the UE 210 performs the DL synchronization after deciding the target cell for conditional LTM (i.e., after triggering the conditional LTM decision), as shown in option 3 in FIG. 3. As the target cell is decided, in operation 521 of scenario 520, the UE 210 may apply the TCI state for the target cell and perform the DL synchronization toward the target cell by itself. In scenario 520, the UE 210 may inform the BS 220 of the TCI state it uses by transmitting an L1 measurement report, or by a preamble (e.g., a random access channel (RACH) procedure during the LTM execution procedure).

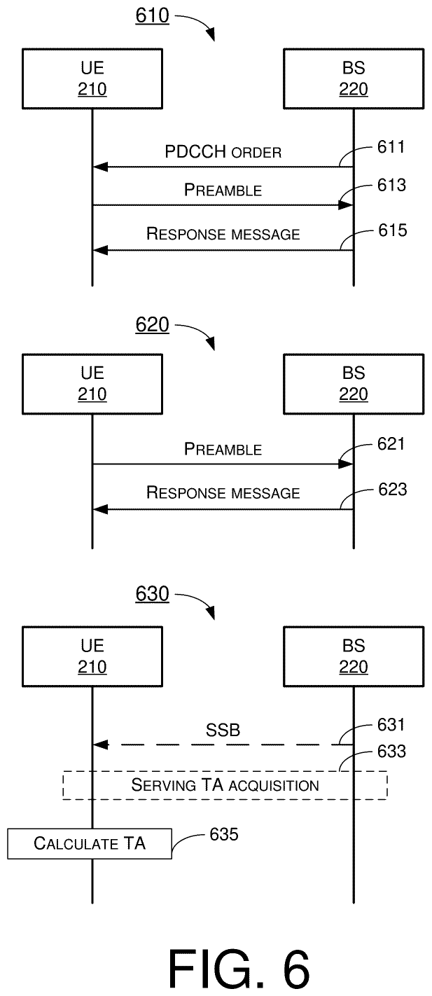

FIG. 6 is a diagram depicting example scenarios of performing UL synchronization for conditional LTM in accordance with an implementation of the present disclosure. As shown in scenarios 610, 620, and 630, the UL synchronization may be performed differently depending on the timing of the conditional LTM decision trigger. In one embodiment, when the UE 210 performs the UL synchronization before deciding the target cell for conditional LTM (i.e., before triggering the conditional LTM decision), as shown in option 1 in FIG. 3, the UE 210 may perform the UL synchronization with the candidate cell(s). To be specific, in operation 611 of scenario 610, the UE 210 receives a physical downlink control channel (PDCCH) order from the source cell associated with the BS 220 and performs a RACH procedure via non contention or contention free random access (CFRA) toward the indicated candidate cell(s). In operation 613, the UE 210 sends a preamble towards the indicated candidate cell(s) associated with the BS 220. In operation 615, the UE 210 receives a response message from the source cell associated with the BS 220. The response message may be delivered/carried by a MAC-CE, a MAC layer message, or a random access response (RAR) message during the RACH procedure, the present disclosure is not limited thereto. More specifically, the TA value(s) of the candidate cell (s) may be included in the response message. In another example, when the PDCCH order received by the UE 210 in operation 611 includes multiple candidate cells, the UL synchronization procedure shown in scenario 610 may also be applied to options 2 and 3 in FIG. 3. That is, the UE 210 may perform the UL synchronization toward the target cell via CFRA after the conditional LTM decision is made.

In one embodiment, the UL synchronization procedure shown in scenario 620 can be applied to options 2 and 3 in FIG. 3. That is, the UE 210 performs the UL synchronization toward the target cell. More specifically, the UE 210 performs the UL synchronization after deciding the target cell for conditional LTM (i.e., after triggering the conditional LTM decision). As shown in operation 621, the UE 210 transmits a preamble towards the target cell associated with the BS 220 for the conditional LTM. In one example, the sending of preamble implicitly indicates the target cell chosen by the UE 210 to the network. In operation 623, a response message is received by the UE 210. For example, the UE 210 may perform the RACH procedure via contention based random access (CBRA) towards the target cell, and the UE 210 may receive a RAR message during the RACH procedure. In one embodiment, the TA value is included in the RAR message.

In scenarios 610 and 620, the response message is received from the source cell after the UE 210 sends the preamble to the target cell or the candidate cell(s). In one embodiment, the cell where the UE 210 sends the preamble transmits the TA value to the source cell. In one embodiment, the response message is used to indicate the TA value for the target cell or the candidate cell(s) to the UE 210. The UE 210 may start a TA valid timer when receiving the response message including the TA value. In one embodiment, the UE 210 may discard the TA value and perform the RACH procedure during the LTM execution procedure if the TA valid timer expires. To be specific, the UE 210 may determine whether the TA valid timer expires during the LTM execution procedure. If the TA valid timer expires, whether before or during the LTM execution procedure, and the UE 210 may discard the TA value and perform the RACH procedure.

The response message shown in scenarios 610 and 620 may be received after the UL synchronization procedure. In another example, the response message may be received during or after the LTM execution procedure from the target cell. In yet another example, the response message may be received when the UE 210 receives the first DL data from the target cell.

The UL synchronization procedure indicated in scenario 630 may be applied to options 1, 2 and 3 in FIG. 3. To be specific, in operation 631, the UE 210 may receive synchronization signal and physical broadcast channel block (SSB) from the serving cell and the target/candidate cell(s). In operation 633, the UE 210 acquires the TA value from the source cell, and in operation 635, the UE 210 calculates TA for the target/candidate cell(s).

In the foregoing embodiments associated with FIG. 6, the UL synchronization is performed before the LTM execution procedure (i.e., a RACH-less LTM). However, in another embodiment, the UL synchronization may be performed during the LTM execution procedure (i.e., a RACH-based LTM). To be specific, the UE 210 may perform a RACH random access procedure toward the target cell during the LTM execution procedure. The type of RACH procedure may be CBRA or CFRA. In one embodiment, the UE 210 may inform the BS 220 of the target cell decision by performing the RACH procedure toward the target cell for the RACH-based LTM.

To reduce mobility latency and interruption for conditional LTM, the UE 210 may perform certain procedure(s) before the LTM execution procedure. Specifically, as shown in option 1 in FIG. 3, the LTM execution procedure is triggered by the conditional LTM decision, and as shown in options 2 and 3 in FIG. 3, the conditional LTM decision is triggered earlier than the LTM execution procedure. During the LTM execution procedure, the T_{LTM_RRC-processing} time refers to the time of abstract syntax notation one (ASN.1) decoding for the radio resource control (RRC) message by the UE 210 (e.g., the RRC parameter received in the LTM preparation stage). The T_{LTM_processing} time refers to the total time of L1, L2 and L3 processing time when the UE 210 detaches from the source cell and applies the configuration for the target cell. The T_{LTM_processing} time can be further divided into T_{LTM_processing} part1, which can be performed in advance before the LTM execution procedure without introducing data interruption; and T_{LTM_processing} part 2, which will lead to data interruption. The procedures which make up T_{LTM_processing} part1 include one or multiple procedures such as the base band preparation, the radio frequency (RF) preparation, the L2 and L3 preparation. The procedures which make up T_{LTM_processing} part2 include one or multiple procedures such as the L2/L3 reset/reestablish procedure, the configuration applying.

In one embodiment, the ASN.1 decoding can be performed before the LTM execution procedure after the UE 210 made the conditional LTM decision. In one embodiment, one or more procedures in T_{LTM_processing} part1 may be performed in advance after the UE 210 made the conditional LTM decision. In one embodiment, one or more procedures in T_{LTM_processing} part2 may be performed in advance after the UE 210 made the conditional LTM decision as a separate capability. That is, the procedure(s) in T_{LTM_processing} part2 may be performed in advance, before detaching from the source cell, depending on whether the UE 210 has a separate set of hardware for this purpose. This capability is reported by the UE 210.

In one embodiment, the DL synchronization procedure and the ASN.1 decoding may be performed/completed in parallel by the UE 210. In one embodiment, one or more procedures in T_{LTM_processing} part1 may be performed/completed in parallel with the DL synchronization procedure and/or the ASN.1 decoding by the UE 210. In one embodiment, the UL synchronization procedure may be performed/completed in parallel with one or more of the DL synchronizations, the ASN.1 decoding and the procedures in T_{LTM_processing} part1 by the UE 210.

Although the forgoing embodiments focus on the conditional intra-CU LTM, it should be noted that the conditional LTM can be used in the inter-CU scenario as well as the intra-CU scenario. UE-triggered LTM decisions not only enhance UE autonomy and flexibility but also improve the accuracy and reasonableness of mobility decisions by leveraging the UE's unique insights into its radio environment.

### Illustrative Implementations

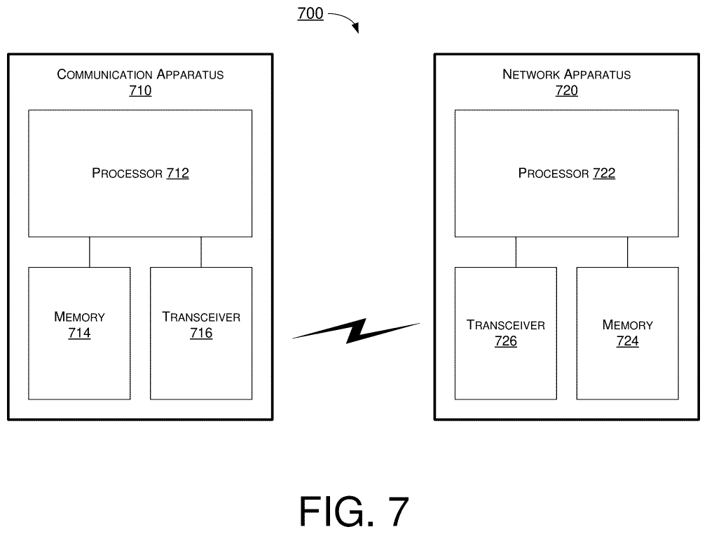

FIG. 7 illustrates an example communication system 700 having at least an example communication apparatus 710 and an example network apparatus 720 in accordance with an implementation of the present disclosure. Each of the communication apparatus 710 and network apparatus 720 may perform various functions to implement schemes, techniques, processes and methods described herein pertaining to conditional LTM in mobile communications, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNB in an LTE network, in a gNB in a 5G/NR, IoT, NB-IoT or IIoT network or in a satellite or base station in a 6G network. Network apparatus 720 may include at least some of those components shown in FIG. 7 such as a processor 722, for example. Processor 722 may further include protocol stacks and a set of control functional modules and circuits. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of the processor 712 and processor 722 may be implemented in the form of one or more single-core processors, one or more multi-core processors, or one or more CISC processors. That is, even though a singular term “a processor” is used herein to refer to processor 712 and processor 722, each of the processor 712 and processor 722 may include multiple processors in some implementations and a single processor in other implementations in accordance with the present disclosure. In another aspect, each of the processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 712 and processor 722 is a special-purpose machine specifically designed, arranged and configured to perform specific tasks in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, communication apparatus 710 may further include a memory 714 coupled to processor 712 and capable of being accessed by processor 712 and storing data therein.

In some implementations, network apparatus 720 may further include a memory 724 coupled to processor 722 and capable of being accessed by processor 722 and storing data therein. Network apparatus 720 may also include a transceiver 726 coupled to processor 722 and capable of wirelessly transmitting and receiving data. Accordingly, communication apparatus 710 and network apparatus 720 may wirelessly communicate with each other via transceiver 716 and transceiver 726, respectively.

For illustrative purposes and without limitation, descriptions of capabilities of the communication apparatus 710 and network apparatus 720 are provided below with process 800 and process 900. In which, communication apparatus 710 is implemented in or as a communication apparatus or a UE, and network apparatus 720 is implemented in or as a network node of a communication network (e.g., a base station).

### Illustrative Processes

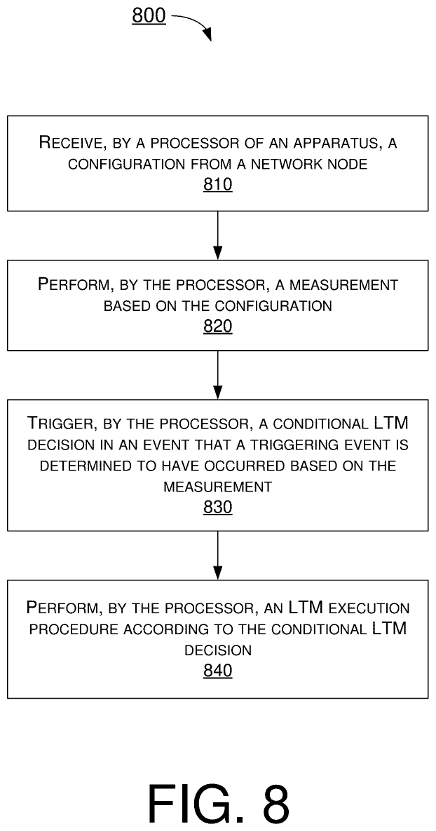

FIG. 8 illustrates an example process 800 in accordance with an implementation of the present disclosure. Process 800 may be an example implementation of above scenarios/schemes, whether partially or completely, with respect to conditional LTM in mobile communications. Process 800 may represent an aspect of implementation of features of communication apparatus 710. Process 800 may include one or more operations, actions, or functions as illustrated by one or more of blocks 810, 820, 830, and 840. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE (e.g., the UE 210) or machine type devices. Solely for illustrative purposes and without limitation, process 800 is described below in the context of communication apparatus 710 as a UE. Process 800 may begin at block 810.

At block 810, process 800 may involve processor 712 of communication apparatus 710 receiving, via transceiver 716, a configuration from a network node (e.g., network apparatus 720 or the BS 220). Process 800 may proceed from block 810 to block 820.

At block 820, process 800 may involve processor 712 performing a measurement based on the configuration. Process 800 may proceed from block 820 to block 830.

At block 830, process 800 may involve processor 712 triggering a conditional LTM decision in an event that a triggering event is determined to have occurred based on the measurement. Process 800 may proceed from block 830 to block 840.

At block 840, process 800 may involve processor 712 performing an LTM execution procedure according to the conditional LTM decision.

In some implementations, the configuration is received in an LTM preparation stage, and the triggering event is configured in the configuration.

In some implementations, the triggering event occurs in an event that a result of the measurement reaches a preconfigured threshold.

In some implementations, process 800 may further involve processor 712 transmitting, via transceiver 716, an L1 measurement report to the network node.

In some implementations, a target cell is determined in the conditional LTM decision. Process 800 may further involve processor 712 switching from a source cell to the target cell.

In some implementations, process 800 may further involve processor 712 informing the network node of the target cell by transmitting an L1 measurement report or a preamble via transceiver 716.

In some implementations, process 800 may further involve processor 712 transmitting, via transceiver 716, a preamble to the target cell in an event that the conditional LTM decision is triggered before a UL synchronization.

In some implementations, process 800 may further involve processor 712 receiving, via transceiver 716, a message comprising a TA value of a candidate cell from the source cell.

In some implementations, the message may be delivered/carried by a MAC-CE or a MAC layer message.

In some implementations, process 800 may further involve processor 712

starting a TA timer in an event that the message comprising the TA value is received.

In some implementations, process 800 may further involve processor 712 discarding the TA value and performing a RACH procedure during the LTM execution procedure in an event that the TA timer is determined to be expired.

In some implementations, process 800 may further involve processor 712 performing a UL synchronization and/or a DL synchronization before or after triggering the conditional LTM decision.

In some implementations, process 800 may further involve processor 712 informing the network node of a TCI state used by communication apparatus 710 by transmitting an L1 measurement report or a RACH procedure during the LTM execution procedure.

In some implementations, process 800 may further involve processor 712 performing one or more procedures before the LTM execution procedure. The procedure(s) may include one or a combination of an ASN.1 decoding for an RRC parameter received in an LTM preparation stage, a base band preparation, an RF preparation, an L2 preparation, and an L3 preparation.

In some implementations, the procedure(s) may be performed after triggering the conditional LTM decision.

In some implementations, the procedure(s) may be performed in parallel with a UL synchronization or a DL synchronization.

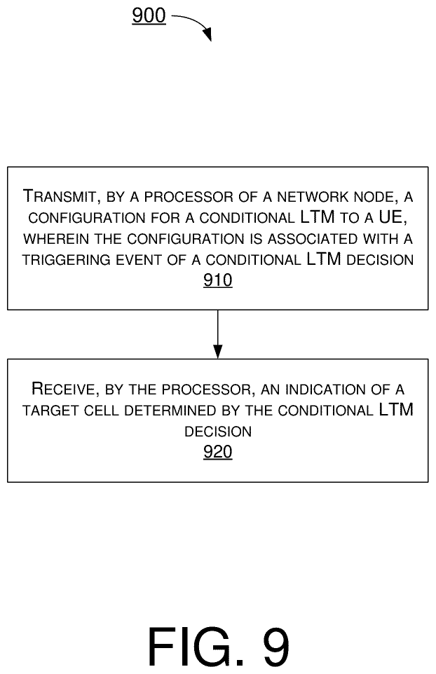

FIG. 9 illustrates an example process 900 in accordance with an implementation of the present disclosure. Process 900 may be an example implementation of above scenarios/schemes, whether partially or completely, with respect to conditional LTM in mobile communications. Process 900 may represent an aspect of implementation of features of network apparatus 720. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any base stations or network nodes (e.g., the BS 220). Solely for illustrative purposes and without limitation, process 900 is described below in the context of network apparatus 720. Process 900 may begin at block 910.

At block 910, process 900 may involve processor 722 of network apparatus 720 transmitting, via transceiver 726, a configuration for a conditional LTM to a UE (e.g., communication apparatus 710 or the UE 210). Specifically, the configuration is associated with a triggering event of a conditional LTM decision. Process 900 may proceed from block 910 to block 920.

At block 920, process 900 may involve processor 722 receiving, via transceiver 726, an indication of a target cell determined by the conditional LTM decision. The conditional LTM decision is made by the UE.

In some implementations, process 900 may further involve processor 722 transmitting, via transceiver 726, a message including a TA value of a candidate cell to the UE.

In some implementations, the message is transmitted by a source cell of the UE.

In some implementations, the message may be delivered/carried by a MAC-CE or a MAC layer message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network node;
performing, by the processor, a measurement based on the configuration;
triggering, by the processor, a conditional layer 1/layer 2 triggered mobility (LTM) decision in an event that a triggering event is determined to have occurred based on the measurement; and
performing, by the processor, an LTM execution procedure according to the conditional LTM decision.

2. The method of claim 1, wherein the configuration is received in an LTM preparation stage, and the triggering event is configured in the configuration.

3. The method of claim 1, wherein the triggering event occurs in an event that a result of the measurement reaches a preconfigured threshold.

4. The method of claim 1, further comprising:
transmitting, by the processor, a layer 1 (L1) measurement report to the network node.

5. The method of claim 1, wherein a target cell is determined in the conditional LTM decision, and the performing of the LTM execution procedure further comprises:
switching from a source cell to the target cell.

6. The method of claim 5, further comprising:
informing, by the processor, the network node of the target cell by transmitting a layer 1 (L1) measurement report or a preamble.

7. The method of claim 5, further comprising:
transmitting, by the processor, a preamble to the target cell in an event that the conditional LTM decision is triggered before an uplink (UL) synchronization.

8. The method of claim 5, further comprising:
receiving, by the processor, a message comprising a timing advance (TA) value of a candidate cell from the source cell.

9. The method of claim 8, wherein the message is delivered by a medium access control (MAC)—control element (CE) or an MAC layer message.

10. The method of claim 8, further comprising:
starting, by the processor, a TA timer in an event that the message comprising the TA value is received.

11. The method of claim 10, further comprising:
discarding, by the processor, the TA value and performing a random access channel (RACH) procedure during the LTM execution procedure in an event that the TA timer is determined to be expired.

12. The method of claim 1, further comprising:
performing, by the processor, at least one of an uplink (UL) synchronization and a downlink (DL) synchronization before or after triggering the conditional LTM decision.

13. The method of claim 1, further comprising:
informing, by the processor, the network node of a transmission configuration indicator (TCI) state used by the apparatus by transmitting a layer 1 (L1) measurement report or a random access channel (RACH) procedure during the LTM execution procedure.

14. The method of claim 1, further comprising:
performing, by the processor, one or more procedures before the LTM execution procedure, wherein the one or more procedures comprises one or a combination of an abstract syntax notation one (ASN.1) decoding for a radio resource control (RRC) parameter received in an LTM preparation stage, a base band preparation, a radio frequency (RF) preparation, a layer 2 (L2) preparation, and a layer 3 (L3) preparation.

15. The method of claim 14, wherein the one or more procedures are performed after triggering the conditional LTM decision.

16. The method of claim 14, wherein the one or more procedures are performed in parallel with an uplink (UL) synchronization or a downlink (DL) synchronization.

17. A method, comprising:
transmitting, by a processor of a network node, a configuration for a conditional layer 1/layer 2 triggered mobility (LTM) to a user equipment (UE), wherein the configuration is associated with a triggering event of a conditional LTM decision; and
receiving, by the processor, an indication of a target cell determined by the conditional LTM decision.

18. The method of claim 17, further comprising:
transmitting, by the processor, a message comprising a timing advance (TA) value of a candidate cell to the UE.

19. The method of claim 18, wherein the message is transmitted by a source cell.

20. An apparatus, comprising:
a transceiver which, during operation, communicates wirelessly; and
a processor communicatively coupled to the transceiver such that, during operation, the processor performs operations comprising:
receiving, via the transceiver, a configuration from a network node;
performing a measurement based on the configuration;
triggering a conditional layer 1/layer 2 triggered mobility (LTM) decision in an event that a triggering event is determined to have occurred based on the measurement; and
performing an LTM execution procedure according to the conditional LTM decision.
